(19) United States
(12) Patent Application Publication
(10) Pub. No.: US 2014/0260748 A1
(43) Pub. Date: Sep. 18, 2014

(54) ONE-PIECE ANTI-BACKLASH NUT

(71) Applicant: Richard Dean Traver, San Diego, CA (US)

(72) Inventor: Richard Dean Traver, San Diego, CA (US)

(73) Assignee: Lincoln Global, Inc., City of Industry, CA (US)

(21) Appl. No.: 13/804,635

(22) Filed: Mar. 14, 2013

(51) Int. Cl. F16H 25/20

(52) U.S. Cl. CPC F16H 25/2003
USPC 74/441

(57) ABSTRACT

The claimed subject matter provides an anti-backlash nut for use with a leadscrew. The nut can include two or more threaded sections and at least one semi-flexible section. The anti-backlash nut can be of one-piece construction and utilize the one or more flexible or biasing sections to apply one or more forces or offsets to the threaded sections to mitigate backlash.

### TECHNICAL FIELD

The invention can relate generally to hardware for use with leadscrews. More particularly, but not by way of limitation, the invention can relate to hardware for mitigating backlash in leadscrews. Most particularly, but not by way of limitation, the invention can relate to an anti-backlash nut for use in conjunction with a leadscrew developed from single-piece construction.

### SUMMARY OF THE INVENTION

This invention relates to an anti-backlash nut that can be used to mitigate backlash in interfaces between threaded portions by biasing two or more threaded portions of a nut against the thread pattern of a leadscrew or other external thread using a yieldable central portion that includes voids in its walls.

In an embodiment, an anti-backlash nut can be provided. The anti-backlash nut can comprise a first section having a first inner diameter and a first outer geometry, the first inner diameter is threaded to interface with a first external thread portion, a second section having a second inner diameter, a second outer geometry, and a partially yieldable portion; and a third section having a third inner diameter and a third outer geometry, the third inner diameter is threaded to interface with a second external thread portion, wherein the first section and the third section are connected at least by the second section, and wherein the second section biases the first section and third section against one another at least based in part on one or more of the first external thread portion and the second external thread portion

Particular embodiments can include a method of producing an anti-backlash nut, comprising producing a first section, the first section is hollow with an internal threading pattern, producing a second hollow section, the second section is hollow and includes at least a semi-flexible portion, producing a third section, the third section is hollow with the internal threading pattern, and manipulating the second hollow section to offset the first hollow section with respect to third hollow section.

Specific embodiments herein can include a self-aligning nut for engagement with external threading that can include at least one central biasing portion of annular construction including one or more cut-out portions that facilitate controlled deformation of the central biasing portion and two or more threaded distal portions of annular construction joined by the at least one central biasing portion.

Various aspects will become apparent to those skilled in the art from the following detailed description and the accompanying drawings.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIGS. 1A, 1B, and 1C illustrate various perspective views of an example embodiment of an anti-backlash nut in accordance with aspects here.

FIGS. 2A, 2B, and 2C illustrate various perspective views of another example embodiment of an anti-backlash nut in accordance with aspects here.

FIGS. 3A, 3B, and 3C illustrate various perspective views of another example embodiment of an anti-backlash nut in accordance with aspects here.

FIGS. 4A, 4B, and 4C illustrate various perspective views of still another example embodiment of an anti-backlash nut in accordance with aspects here.

FIG. 5 illustrates an example block diagram of an embodiment of a methodology for manufacturing an anti-backlash nut in accordance with aspects herein.

FIG. 6 illustrates an example block diagram of an embodiment of a methodology for manufacturing an anti-backlash nut in accordance with aspects herein.

### DETAILED DESCRIPTION

The subject innovation can generally relate to an anti-backlash nut, or other means for mitigating gaps between interfacing solid materials that can result from production tolerances, wear, imperfect machining, and other causes. The desired result can be accomplished, at least in part, by biasing or offsetting two interfacing portions in a way that separates the portions by a value that closes the gaps.

For example, an anti-backlash nut can have two threaded portions that, rather than employ continuous internal threading, are joined by a non-threaded portion that offsets the threading on the two portions by a value that forces the opposing threads in each respective portion against the mating surface of the external threading. In embodiments, the non-threaded portion can be at least semi-flexible (e.g., yieldable) such as can be accomplished by use of linear slits, helical design, and other configurations that permit at least limited motion in one dimension to allow stretching or compressing of the nut to a value that allows the distal threaded portions to pick up or mitigate the slop that would be inherent in a continuously-threaded nut.

The innovation can be of one-piece construction, and can particularly be prepared from a single portion of solid material. In embodiments, after applying the non-threaded portion (e.g., removal of otherwise continuous material by machining slits or a helical pattern), the nut or other means for mitigating gaps can be stretched, compressed, twisted, or otherwise modified by a value greater than 0 but less than or equal to a gap size or tolerance to facilitate mitigation or elimination of gaps (e.g., backlash, tolerances, slop, play, et cetera) in the interface of the distal threaded portions with a screw or other component with which the nut interfaces.

As used herein, spatially orienting terms such as “above,” “below,” “upper,” “lower,” “inner,” “outer,” “right,” “left,” “vertical,” “horizontal,” et cetera, can refer to respective positions of aspects as shown in the accompanying drawings. Such terms are employed for purposes of clarity in describing the drawings, and should not be construed as exclusive, exhaustive, or otherwise limiting with regard to position, orientation, perspective, configuration, and so forth.

Referring now to the drawings, there is illustrated in FIGS. 1A, 1B, and 1C various perspective views of an example embodiment of an anti-backlash nut 100 in accordance with aspects here. Anti-backlash nut 100 can interface with the external threads of a screw. In particular, by interfacing with the external threads of a leadscrew, anti-backlash nut 100 can facilitate, for example, precise translation along the axis of the leadscrew.

Anti-backlash nut 100 can include first threaded section 110 and second threaded section 130 joined by an integral flexible section 120. In embodiments, first threaded section 110, second threaded section 130, and flexible section 120 can be formed from a single piece of material.

First threaded section 110 and second threaded section 130 can have annular walls through which threaded bores 112 and 132 pass coincidentally. Threaded bores 112 and 132 can include interior threads that engage with the exterior threads of a screw (e.g., a leadscrew) and can translate along the screw when the screw is turned (or when anti-backlash nut 100 is turned).

Flexible section 120 can include slits 122 where material has been removed from the annular body of flexible section 120. Slits 122 can define voids or patterns that facilitate at least limited linear and/or rotational flexure in flexible section 120. Slits 122 can be applied, for example, by machining a cylindrical blank about its circumference. As shown in FIGS. 1B and 1C, slits 122 can include a non-continuous portion that can be described as a portion of a ring removed from the annular walls of flexible section 120 (e.g., portion of circumference of flexible section 120 removed or absent).

Slits can be defined by a plurality of values, including their width (e.g., 2-dimensional measurement along axial direction), the width they are separated by, the rotational value they are separated by, and a measurement describing the proportion of the circumference of flexible section 120 that they traverse. The rotational value by which the slits 122 are separated can be an angular offset (e.g., annular wall of flexible section 120 defines 360 degrees, consecutive slits are offset by a degree value), a linear offset (e.g., length along circumference by near ends of slits are separated), and others. The value describing the proportion of the circumference of flexible section 120 traversed can include a slit depth (e.g., logically describing the slit as a cut through a continuous cylinder, a linear value or proportion of diameter through which a straight-line cut through the tubular structure would produce the desired configuration), a slit angle (e.g., rotational value or proportion of 360-degrees covered by a slit, with the circular cross-section of the flexible section defining 360-degrees), a slit length (e.g., linear measurement of the slit if circumference of flexible section 120 was “unrolled”), and others. Some such values are described in FIGS. 3B and 3C. Those of ordinary skill in the art will appreciate other means of describing slits and other values or measurements inherent that do not depart from the scope or spirit of the innovation herein.

In embodiments, slits 122 can take any variety of shapes and sizes. While illustrated embodiments generally show slits 122 in a single embodiment as symmetrical, it is unnecessary that all slits in a single embodiment be substantially similar. Two or more slits in a single embodiment can include one or more varying widths, depths/lengths, separations, and other values. In embodiments, one or more of slits 122 can wrap approximately nine tenths of the circumference of flexible section 120 (e.g., slit angle of approximately 330 degrees). In embodiments, one or more of slits 122 of slits 122 can wrap approximately one tenth of the circumference of flexible section 120 (e.g., slit angle of approximately 35 degrees).

In one or more specific embodiments, a slit width for one or more slits 122 can be 0.063 inches. In specific alternative or complementary embodiments, the linear slit offset for one or more slits 122 can be 0.063 inches. In embodiments, a slit depth for one or more slits 122 can be approximately 0.400 inches where an outer diameter of flexible section 120 (e.g., diameter between outer edges of annular wall of flexible section 120) is approximately 0.750 inches. In an alternative embodiment, the slit depth can be 0.425 inches. Alternative values related to slit geometry can be employed without departing from the spirit or the scope of the innovation.

In embodiments, slits 122 can have interior walls of varying angles. For example, one or more interior walls of slits 122 can align with a radial or transverse line such that different corresponding walls of two or more of slits 122 (e.g., if each slit has 4 walls and assumes a rectangular shape if laid flat) do not define parallel planes. In alternative or complementary examples, one or more interior walls of slits 122 can align with an arbitrary line such that corresponding walls of two or more of slits 122 define parallel planes.

In various embodiments, there can be a number of slits 122. For example, embodiments of anti-backlash nut 100 can have two slits 122. In an alternative example, embodiments of nut anti-backlash 100 can have several dozen slits 122. Various characteristics and/or amounts related to flexibility, failure resistance, weight, geometries, and other qualities can be effected by particular numbers and patterns of slits. Slits can be asymmetrical, and it is not required that any two slits be of similar configuration or orientation. Nonetheless, in embodiments, all slits 122 can be similarly designed.

While slits 122 have been described, to facilitate understanding, in terms of cutting, removing, forming, et cetera, such aspects are intended to convey the concept of slits 122 only, and should not be interpreted as limiting the design, method of manufacture, and/or other aspects of the scope or spirit of the subject innovation. In addition to creating slits 122 in a preexisting cylindrical blank, in embodiments the annular body of flexible section 120 can be formed with slits 120 (e.g., no need to machine slits 122 out of continuous blank).

In embodiments, the inner diameter of flexible section 120 can be unthreaded, smooth, or of other pattern/texture. The inner diameter of flexible section 120 can be equal to or greater than a maximum cross section of a screw (or other component) that is used in conjunction or interfaces with anti-backlash nut 100. In embodiments, the center line defining the bore of flexible section 120 can coincide with the line defining the bores of one or both of first threaded section 110 and second threaded section 130. In embodiments, one or more bore centerlines for first threaded section 110, flexible section 120, and second threaded section 130 need not coincide. In embodiments, regardless of whether bores of first threaded section 110, flexible section 120, and second threaded section 130 coincide, first threaded section 110, flexible section 120, and second threaded section 130 can have two or more inner (or bore) diameters (e.g., not all of same internal dimensions) and/or two or more outer diameters or dimensions (e.g., not all of same external dimensions).

As suggested, flexible section 120 can be sized to offset the alignment of the internal threading in first threaded section 120 and second threaded section 130 to pick up the backlash. Were this not the case, such as if the threading was continuous through an entire component or aligned between discontinuous portions of threading, backlash would still exist. By offsetting two portions that each interface with threads, first threaded section 110 and second threaded section 130 can be offset by an amount less than or equal to the backlash amount such that some or all of the backlash is mitigated.

In embodiments, upon production of at least a portion of anti-backlash nut 100 (e.g., one or more outer geometries formed, inner diameter(s) bored, slits 122 formed, and/or other processes completed) anti-backlash nut 100 (or a partially-completed embodiment thereof) can be stretched, compressed, twisted, or have other manipulations performed in order to apply the necessary offset to reduce backlash. For example, anti-backlash nut 100 can be machined to have the threading from first threaded section 110 and second threaded section 120 aligned such that if the threading continued between both sections there would be no interruption, discontinuity, or collision. Upon manipulation of flexible section 120, an offset can exist such that the threading pattern of first threaded section 110 is offset from that of second threaded section 130 by an amount up to a backlash value. In alternative or complementary embodiments, anti-backlash nut 100 can be constructed with an offset built-in. Whether through manipulation of flexible section 120 or as-manufactured, the offset can be designed around a backlash value based on actual measured backlash, average measured backlash, theoretical backlash, and other possible values of backlash.

By employing flexible section 120, multiple backlash values can be accommodated. For example, as a machine is used, wear to a leadscrew may change the backlash value. Alternatively, anti-backlash nut 100 can be used with or moved between two or more machines or leadscrews that have differing tolerances and accordingly differing backlash. Anti-backlash nut 100 can be re-sized to more precisely accommodate specific backlash values through ongoing stretching, compressing, twisting, et cetera. Such re-adjustment can be performed by hand or with use of machines in varying embodiments. In embodiments, anti-backlash nut 100 can be relieved after one or more adjustments. Initial sizing or resizing can be based at least in part on the lead and/or pitch of external screw threading.

Turning now to FIGS. 2A, 2B, and 2C, illustrated are various perspective views of another example embodiment of an anti-backlash nut 200 in accordance with aspects here. Unlike anti-backlash nut 100, anti-backlash nut 200 can include a helically-shaped biasing portion 220 instead of slits. FIG. 2C further includes leadscrew 250.

Anti-backlash nut 200 can have first threaded section 210, second threaded section 230, and biasing section 220. Biasing section 220 can join first threaded section 210 and second threaded section 220, and facilitate adjustment of an offset between the threading of first threaded section 210 and second threaded section 230. Anti-backlash nut 200 can have nut length 206, which can be the combined lengths of first threaded section 210, second threaded section 230, and biasing section 220. In embodiments, nut length 206 can change based on modification of biasing section 220 (e.g., stretching, compressing, twisting, et cetera).

First threaded section 210 can have first inner diameter 212, first outer diameter 214, and first threaded length 216. First inner diameter 212 can be, in embodiments, first inner diameter 212 can be the diameter of the bore before first threaded section 210 is threaded or tapped. In alternative embodiments, first inner diameter 212 can be the diameter after first threaded section 210 is threaded or tapped, and can be the diameter between peaks or troughs of the threading. In embodiments, first inner diameter 212 can be 0.400 inches. In alternative embodiments, first inner diameter 212 can be 0.425 inches. Other embodiments will be appreciated by those skilled in the art, and can be dependent upon the diameter of leadscrew 250 (or another component) with which anti-backlash nut 200 can be used.

First outer diameter 214 can be the diameter of first threaded section 210 including the cylindrical wall. In embodiments, at least a portion of first section 210 and/or first outer diameter 214 can be beveled, notched, textured, et cetera. In such embodiments, first outer diameter 214 can be the largest diameter of first section 210. In specific embodiments, first outer diameter can be 0.730 inches. In alternative embodiments, first outer diameter can be 0.750 inches. Other embodiments will be appreciated by those skilled in the art, and can be dependent upon a particular use for anti-backlash nut 200.

First threaded length 216 can be a two-dimensional measurement of first threaded section 210 along an axial direction. In specific embodiments, first threaded length 216 can be 0.313 inches. Other embodiments will be appreciated by those skilled in the art, and can be dependent upon a particular use for anti-backlash nut 200.

Similarly, second threaded section 230 can have second inner diameter 232, second outer diameter 234, and second threaded length 236. Second inner diameter 232 can be, in embodiments, the diameter of the bore before second threaded section 230 is threaded or tapped. In alternative embodiments, second inner diameter 232 can be the diameter after second threaded section 230 is threaded or tapped, and can be the diameter between peaks or troughs of the threading. In embodiments, second inner diameter 232 can be 0.400 inches. In alternative embodiments, second inner diameter 232 can be 0.425 inches. Other embodiments will be appreciated by those skilled in the art, and can be dependent upon the diameter of leadscrew 250 (or another component) with which anti-backlash nut 200 can be used.

Second outer diameter 234 can be the diameter of second threaded section 230 including the cylindrical wall. In embodiments, at least a portion of second section 230 and/or second outer diameter 234 can be beveled, notched, textured, et cetera. In such embodiments, second outer diameter 234 can be the largest diameter of second section 230. In specific embodiments, second outer diameter can be 0.730 inches. In alternative embodiments, second outer diameter can be 0.750 inches. Other embodiments will be appreciated by those skilled in the art, and can be dependent upon a particular use for anti-backlash nut 200.

Second threaded length 236 can be a two-dimensional measurement of second threaded section 230 along an axial direction. In specific embodiments, second threaded length 236 can be 0.313 inches. Other embodiments will be appreciated by those skilled in the art, and can be dependent upon a particular use for anti-backlash nut 200.

The thickness of the walls of first threaded section 210 and second threaded section 230 (and/or at least a portion of a wall, helix, et cetera, of biasing section 220) can be defined by the difference between respective inner and outer diameters.

Biasing section 220 can include an integral helical configuration that can have a limited ability to flex or deform in one or more translational or rotational dimensions without failing. Biasing section 220 can have biasing inner diameter 222, biasing outer diameter 224, and biasing length 226. In embodiments, biasing inner diameter 222 can be greater than one or both of first inner diameter 212 and/or second inner diameter 232. In embodiments, biasing inner diameter 222 can be less than one or both of first inner diameter 212 and/or second inner diameter 232. In embodiments, biasing outer diameter 224 can be great than one or both of first outer diameter 214 and/or second inner diameter 234. In embodiments, biasing outer diameter 224 can be less than one or both of first outer diameter 214 and/or second inner diameter 234. In embodiments, biasing inner diameter 222 and/or biasing outer diameter 224 can be equal to corresponding surfaces on one or both of first threaded section 210 and second threaded section 230.

Biasing length 226 can be one or more lengths along an axial direction of biasing section 220. In embodiments, biasing length 226 can change according to various actions and/or treatments effected on biasing section 220 (or anti-backlash nut 200 as a whole). For example, biasing section 210 can be compressed, stretched, twisted, et cetera, in such a way that biasing length (and accordingly, nut length 206) change. In a particular embodiment, biasing length 226 can be 0.376 inches as-produced, and later change according to manipulation.

While the foregoing has described anti-backlash nut 200 predominantly in terms of cylindrical configurations, it is to be appreciated that anti-backlash nut 200, and other embodiments described herein, need not include rounded geometries, and can take any variety of shape or size to accommodate particular uses without departing from the scope or spirit of the innovation. For example, polygonal cross-sections for one or more of first threaded section 210, biasing section 220, and/or second threaded section 230 can be employed in embodiments.

FIGS. 3A, 3B, and 3C illustrate various perspective views of another example embodiment of an anti-backlash nut 300 in accordance with aspects here. Anti-backlash nut 300 can include first section 310, second section 320, and third section 330. First section 310 and third section 330 can include a threaded inner diameter. Second section 320 can include slits 322.

The slits can have a width dimension, and can be separated by a separation dimension. In various embodiments, slits 322 can have slit separation 324 and slit width 326. Slits 322 can additionally have slit length 328 and slit offset 329. Slit offset can be a distance or angle by which the ends of respective slits are offset from one another about the circumference of the annular walls of second section 320. In various embodiments, slit width 326 can (but need not) be equal to a slit separation 324. Further, while illustrated embodiments show symmetrical dimensions of slits 322, it is to be appreciated that two or more of slits 322 need not have the same slit separation 324, slit width 326, slit length 328, and/or slit offset 329.

Anti-backlash nut 300 is shown with thinner annular walls and a different total number of slits 322 than other illustrated embodiments. Such functional and aesthetic aspects, while not intended to be limiting, suggest further the breadth and various possible embodiments cognizable under the disclosures herein.

FIGS. 4A, 4B, and 4C illustrate various perspective views of still another example embodiment of an anti-backlash nut 400 in accordance with aspects here. Anti-backlash nut 400 is shown with tapered conical section 410, second section 320 of consistent cross-section, and parallelepiped section 430. Such functional and aesthetic aspects, while not intended to be limiting, suggest further the breadth and various possible embodiments cognizable under the disclosures herein. Tapered conical section 410 can include taper angle 412 defining the pitch of the wall of tapered conical section 410 (e.g., with respect to a bore centerline). Parallelepiped section 430 can include step height 432 that can define the boundaries of parallelepiped section 430 with respect to the dimensions of at least a cross-section of second section 320.

FIGS. 5 and 6 relate to example methodologies for making one or more anti-backlash nuts in accordance with aspects herein. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

FIG. 5 illustrates a flow chart of an example embodiment for a methodology 500 related to fabricating a one-piece anti-backlash nut. At 502, methodology 500 can start and proceed to 504 where material is placed for machining. For example, a blank or appropriately sized piece of metal, plastic, et cetera, can be positioned for work.

Upon placing the material at 504, methodology 500 can proceed to 506 where inner and outer diameters can be turned to form the surfaces and shape of the one-piece anti-backlash nut. Turning inner and outer diameters at 506 can be accomplished with a variety of machines or manufacturing techniques. For example, various turning systems, lathes, torches, grinders, cutters, lasers, and so forth can be employed. While methodology 504 includes language directed to round configurations, it is to be appreciated that other geometries, particularly with respect to exterior dimensions, can be utilized without departing from the scope or spirit of the subject innovation.

Inner and outer diameters (or other dimensions) need not remain constant for the entirety of the body of the anti-backlash nut, and varying sizes and geometries can be employed. Such aspects can be formed, machined, produced, et cetera, simultaneously, consecutively, or in separate tasks.

At 508, slits can be cut into at least a portion of an anti-backlash nut to form a flexible (or partially flexible) section. Slits can be cut at 508 using machines similar to those employed at 506 or alternative equipment. The one or more slits can be cut with one or more widths, separations, lengths, offsets, and other measurements.

After the slits are completed at 508, the partial anti-backlash nut can be compressed, expanded, twisted, or otherwise manipulated, at least in part about the slits, to offset or pick-up a backlash amount. In embodiments, this aspect can be performed later (e.g., after threading at 512, after relieving at 514, and others).

At 512, threads can be tapped to add threading to the inner diameter. The threads can be tapped to each section separated by the section carrying the slits separately. In alternative or complementary embodiments, threading can be continuously applied through both sections separated by the section carrying the slits, and the nut can be adjusted again subsequently (e.g., as at 510) to mitigate backlash.

At 514, the material can be relieved. For example, the anti-backlash nut can have an annealing treatment completed to relieve stress in the nut. While this aspect is shown at 514, it is appreciated that relieving the material can be performed before, after, or between any aspect(s) described in methodology 500.

After the anti-backlash nut is completed, adjusted, and/or relieved, methodology 500 can end.

FIG. 6 illustrates an example block diagram of an embodiment of a methodology 600 for manufacturing an anti-backlash nut in accordance with aspects herein. Methodology 600 can start at 602 and proceed to 604 where exteriors and bores of sections of an anti-backlash nut can be formed. Exteriors and/or bores can take any shape and be formed in any fashion. In embodiments, two or more bore diameters can be applied (e.g., center section wider bore than distal sections).

At 606, a flexible interface is applied. Where the single-piece construction is developed from a single piece of material (e.g., through machining, through molding), the flexible interface can be applied to at least a section (e.g., a center section). For example, various slit or helical patterns can be cut, melted, punched, bent, et cetera. In particular alternative embodiments, a flexible interface can be applied by permanently attaching a flexible portion to the distal sections that are created independently (e.g., flexible material or spring bonded, welded, or otherwise applied to hold two portions together). Despite inclusion of such aspects herein, embodiments will generally be formed as a single-piece rather than assembled to single-piece.

At 608, the partial anti-backlash nut can be threaded. At least the distal sections connected by center section (which includes the flexible interface) can be threaded to interface with a screw. In embodiments, threading can occur before applying the flexible section at 606. After the anti-backlash nut has the flexible interface applied and is threaded, methodology 600 can end at 610.

While methodologies generally describe machining metals or other hard fabrication materials, other techniques for developing an anti-backlash nut in accordance with the herein can be employed in alternative or complementary embodiments. For example, an anti-backlash nut can be molded as a single piece. In alternative or complementary embodiments, multiple portions can be individually molded or formed (e.g., halves, thirds, quarters, or other symmetrical or asymmetrical portions) and joined (e.g., welded, fused, bonded, and others) thereafter. In embodiments cognizable under the disclosures herein, a single-piece anti-backlash nut can be developed using a three-dimensional printer or other techniques.

Embodiments herein can be configured to employ a variety of thread types for leadscrews or other applications. For example, screws employing a buttress thread, round thread, square thread, and others can be employed. Various screw configurations of different threadform, angle, lead, pitch, depth, diameters, cross-sections (e.g., round, square, triangular, et cetera) and other characteristics can be utilized with the anti-backlash nut described herein without departing from the scope or spirit of the innovation.

In various embodiments, an anti-backlash nut (or other component described herein) can be developed, formed, machined, and/or built from, for example, materials such as iron or its alloys, copper or its alloys, and other metals. In embodiments, anti-backlash nut can be formed from plastics, composites, or ceramics.

In embodiments, an anti-backlash nut or component thereof can be formed from a single-piece blank of multiple materials. For example, a blank including different layers of suitable materials, different sections of suitable materials (e.g., different portions are attached to a single-piece blank through fusing, bonding, and/or other appropriate techniques), or other multi-material configurations can be employed to produce a single-piece result.

In embodiments, various coatings or treatments can be applied to a single-piece anti-backlash nut or components thereof. For example, corrosion-resisting treatments such as phosphating, bluing, anodizing, and others can be applied to an anti-backlash nut or components thereof. In alternative or complementary embodiments, anti-friction coatings such as plastic, porous metals, graphite-impregnated materials, oil-impregnated materials, polytetrafluoroethylene (PTFE) or similar products, and/or alternatives can be utilized without departing from the scope or spirit of the innovation.

Various embodiments herein describing flexible portions can have various limited motion in varying degrees, and be at least partially bendable, stretchable, compressible, rotatable, et cetera, without failure. While anti-backlash nuts herein generally contemplate reducing backlash along a linear screw, it is to be appreciated that such flexible portions can be used to reduce or eliminate play from dimensional tolerances in one or more linear and/or rotational dimensions.

Embodiments herein are directed toward use of the anti-backlash nut with threaded screws. However, it is to be appreciated that the techniques herein can be applied to reduce backlash, play, slop, et cetera in other multi-part assemblies. For example, fixed sections connected at least by a flexible section can be used with various other assemblies (e.g., of linear configuration) where two or more components interface at a tolerance desirable to be reduced or can move with respect to one another in at least one dimension.

While principles and modes of operation have been explained and illustrated with regard to particular embodiments, it must be understood, however, that this may be practiced otherwise than as specifically explained and illustrated without departing from its spirit or scope.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

Specific embodiments of an innovation are disclosed herein. One of ordinary skill in the art will readily recognize that the innovation may have other applications in other environments. In fact, many embodiments and implementations are possible. The following claims are in no way intended to limit the scope of the subject innovation to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the subject innovation has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (e.g., enclosures, sides, components, assemblies, etc.), the terms (including a reference to a “means”) used to describe such elements are intended to correspond, unless otherwise indicated, to any element which performs the specified function of the described element (e.g., that is functionally equivalent), even though not structurally equivalent to the disclosed structure which performs the function in the herein illustrated exemplary embodiment or embodiments of the innovation. In addition, while a particular feature of the innovation may have been described above with respect to only one or more of several illustrated embodiments, such feature may be combined with one or more other features of the other embodiments, as may be desired and advantageous for any given or particular application. Although certain embodiments have been shown and described, it is understood that equivalents and modifications falling within the scope of the appended claims will occur to others who are skilled in the art upon the reading and understanding of this specification.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. An anti-backlash nut, comprising:
a first section having a first inner diameter and a first outer geometry, the first inner diameter is threaded to interface with a first external thread portion;
a second section having a second inner diameter, a second outer geometry, and a partially yieldable portion; and
a third section having a third inner diameter and a third outer geometry, the third inner diameter is threaded to interface with a second external thread portion,
wherein the first section and the third section are connected at least by the second section, and
wherein the second section biases the first section and third section against one another at least based in part on one or more of the first external thread portion and the second external thread portion.

2. The anti-backlash nut of claim 1, wherein the partially yieldable portion includes two or more transverse slits.

3. The anti-backlash nut of claim 1, wherein the partially yieldable portion includes a helical structure.

4. The anti-backlash nut of claim 1, wherein the partially yieldable portion is integral to the second section, and the second section is integral with the first section and the third section.

5. The anti-backlash nut of claim 1, wherein the second section biases the first section and third section against one another at least based in part on one or more of the first external thread portion and the second external thread portion by changing a length of the second section.

6. The anti-backlash nut of claim 1, wherein the first section, the second section, and the third section are produced from a single portion of material.

7. The anti-backlash nut of claim 1, wherein at least the first inner diameter and the third inner diameter are equal.

8. The anti-backlash nut of claim 1, wherein the second inner diameter is larger than one or more of the first inner diameter and the third inner diameter.

9. The anti-backlash nut of claim 1, wherein the first outer geometry is smaller than the third outer geometry.

10. The anti-backlash nut of claim 1, the first external thread portion and the second external thread portion define a backlash value.

11. A method of producing an anti-backlash nut, comprising:
producing a first section, the first section is hollow with an internal threading pattern;
producing a second hollow section, the second section is hollow and includes at least a semi-flexible portion;
producing a third section, the third section is hollow with the internal threading pattern; and
manipulating the second hollow section to offset the first hollow section with respect to third hollow section.

12. The method of claim 11, further comprising:
positioning a continuous portion of material for production, wherein the first section, the second section, and the third section are produced from the continuous portion of material.

13. The method of claim 11, wherein manipulating the second section includes one or more of stretching, compressing, and twisting at least a portion of the second section.

14. The method of claim 11, further comprising tapping the internal threading pattern into at least one of the first section and the third section.

15. The method of claim 11, further comprising relieving a material of the anti-backlash nut.

16. The method of claim 11, wherein producing the second hollow section includes producing two or more transverse slits that comprise at least part of the semi-flexible portion in the second section.

17. The method of claim 11, wherein producing the second section includes producing a helical pattern that comprises at least part of the semi-flexible portion in the second section.

18. The method of claim 11, wherein producing the second section includes boring a second diameter greater than at least one of a first diameter of the first section and a third diameter of the third section.

19. A self-aligning nut for engagement with external threading, comprising:
at least one central biasing portion of annular construction including one or more cut-out portions that facilitate controlled deformation of the central biasing portion; and
two or more threaded distal portions of annular construction joined by the at least one central biasing portion.

20. The self-aligning nut of claim 19, wherein the at least one central biasing portion and the two or more threaded distal portions are formed of a single integral piece.
